(19) United States
(12) Patent Application Publication
(10) Pub. No.: US 2021/0107295 A1
(43) Pub. Date: Apr. 15, 2021

(54) PRINTING DEVICE AND PRINTING METHOD

(71) Applicant: MIMAKI ENGINEERING CO., LTD., Nagano (JP)

(72) Inventor: Masaru OHNISHI, Nagano (JP)

(73) Assignee: MIMAKI ENGINEERING CO., LTD., Nagano (JP)

(21) Appl. No.: 17/064,569

(22) Filed: Oct. 6, 2020

(30) Foreign Application Priority Data
Oct. 11, 2019 (JP) 2019-187902

(51) Int. Cl. B41J 11/00; B41M 7/00; B41J 2/045; B41J 2/21

(52) U.S. Cl. CPC B41J 11/002; B41J 2/21; B41J 2/04586; B41M 7/0081

(57) ABSTRACT

A printing device performs printing through an inkjet system includes an inkjet head, an ultraviolet irradiator, and a controller. An ink ejected by the inkjet head contains a curable substance and a solvent. The controller is configured to: cause the inkjet head to perform an ejecting operation; cause the ultraviolet irradiator to perform a viscosity increasing operation and a curing operation; cause, in the viscosity increasing operation, the ultraviolet irradiator to irradiate the ink with ultraviolet light to evaporate at least a part of the solvent in the ink by heat of polymerization and increase the viscosity of the ink to a viscosity at which smearing does not occur on the medium; and cause, in the curing operation, the ultraviolet irradiator to irradiate the ink with ultraviolet light to cure the ink on the medium.

### CROSS REFERENCE TO RELATED APPLICATIONS

This application claims the priority benefit of Japanese Patent Application No. 2019-187902, filed on Oct. 11, 2019. The entirety of the above-mentioned patent application is hereby incorporated by reference herein and made a part of this specification.

### TECHNICAL FIELD

The present disclosure relates to a printing device and a printing method.

### DESCRIPTION OF THE BACKGROUND ART

Conventionally, an inkjet printer, which is a printing device that performs printing through an inkjet system, has been widely used. In an inkjet printer, for example, an evaporation-drying type (evaporation-drying type) ink containing a solvent such as water or an organic solvent (solvent) as a main component is widely used. Furthermore, for example, ultraviolet-curable ink (UV curable ink) and the like are also used as ink for inkjet printers. In this case, the ultraviolet-curable ink is an ink that causes a polymerization reaction of a monomer, an oligomer or the like to occur to increase the viscosity of the ink and stops smearing to fix the ink. Furthermore, in this case, the ink is fixed to the medium before smearing occurs in the ink usually, by applying ultraviolet light immediately after the ink has landed on the medium (media) to be printed. Since the ultraviolet-curable ink can be printed on various media, it is widely used, for example, in the field of digital decoration, and the like. In recent years, solvent UV ink (SUV ink) and the like has also been put to practical use as an ink for the inkjet printer (see e.g., Japanese Unexamined Patent Publication No. 2014-104593, Patent Literature 1). The solvent UV ink is an ink obtained by adding a solvent to an ultraviolet-curable ink so that the main component of the solvent of the ink before curing (before UV curing) becomes the solvent.

Patent Literature 1: Japanese Unexamined Patent Publication No. 2014-104593

When printing is performed with an inkjet printer having a conventional configuration using a conventional ink, the following problems may occur. For example, when an evaporation-drying type ink is used, the ink smearing is likely to occur, and it is considered that the type of usable media is limited. Furthermore, for example, in a multi-pass printer that performs printing in a multi-pass method, the temperature of the heater that heats the medium to evaporate the solvent in the ink is difficult to be increased, and thus it usually becomes necessary to perform printing with a great number of pass numbers (e.g., about 8 to 32 passes or more). Moreover, as a result, the printing speed may be significantly reduced.

Furthermore, when the ultraviolet-curable ink is used, it is considered that the ink layer becomes thick (thickness of the ink) and the printing surface (print surface) becomes matte (roughened surface). More specifically, for example, when the ultraviolet-curable ink is used, ultraviolet light is usually applied immediately after the ink has landed on the medium to suppress the occurrence of smearing, streaks, and the like. Then, in this case, it is conceivable that the printing surface becomes matte in a concave-convex form by curing the ink before the ink is sufficiently flattened. Furthermore, more specifically, in a case where the ultraviolet-curable ink is used, when an image in which the printing rate of an ink of one color is 100% is printed, the average thickness of the layer of ink is about 20 μm for one layer, and about 40 μm for two layers. Then, in this case, when the ink layer is printed using, for example, inks of three colors, the thickness of the ink layer (total thickness) increases to about 60 μm. Since such a thickness is close to the paper thickness of a book or the like, for example, if double-sided printing is performed on a medium (printing paper etc.) for a catalog or a color printing magazine, a gap forms between the overlapped media due to the influence of the thickness of the ink layers. As a result, it may become difficult to use in applications where the medium is overlapped for use such as applications for bookbinding.

Furthermore, for example, when the ultraviolet-curable ink is used in a multi-pass printer, and the like, streak-like spots may form along the moving direction of the inkjet head as the adjacent pre-cured dots may connect to each other. Moreover, since many monomers and oligomers have high viscosity, it is considered that the range of selection of materials that can be used in the ultraviolet-curable ink is narrowed. In addition, for example, in order to widen the selection range of materials used as monomers and oligomers and stabilize the ejection by the inkjet head, it is necessary to heat, at all times, the inkjet head with a heater to reduce the viscosity of the ink. In this case, it is conceivable that the consumption of standby electric power due to heating will increase and that the ink supply will become unstable due to the increased viscosity of the ink in the flow path of an unheated ink, and the like.

On the other hand, when the solvent UV ink is used, the problems of thickening of ink and generation of matte that occur when the ultraviolet-curable ink is used can be appropriately solved. Furthermore, in this case, for example, it becomes possible to use the monomer or oligomer having a high viscosity as it is by using a solvent having compatibility with the monomer or oligomer as the solvent. Moreover, since the viscosity of the ink reduces by adding the solvent, the ink can be ejected more appropriately even when the inkjet head is not heated.

However, when the solvent UV ink is used in the configuration of the conventional printing device, a heater or the like for heating the medium is usually used to evaporate the solvent in the ink. In this case, for example, it is considered that nozzle clogging or the like is likely to occur in the inkjet head as the medium is heated with the heater at a position facing the inkjet head. Furthermore, in the solvent UV ink, smearing may easily occur as in the case where the evaporation-drying type ink is used if the ink contains a large amount of solvent (organic solvent etc.). The present disclosure provides a printing device and a printing method capable of solving the problems described above.

### SUMMARY

The inventor of the present application conducted a thorough research on an ink and a configuration of a printing device that can perform printing more appropriately through an inkjet system. Then, the inventor paid attention to the fact that the problem that occurs when the ultraviolet-curable ink is used in the conventional configuration can be solved by adding a small amount of solvent to the ultraviolet-curable ink. In this case, it was found that if the solvent is a small amount, the solvent can be evaporated by utilizing the heat of polymerization of a monomer, an oligomer or the like which is a curable substance in the ink. Furthermore, in this case, the smearing can be suppressed from occurring by setting the amount of solvent in the ink to only a small amount that can be evaporated by the heat of polymerization. Thus, for example, the solvent in the ink can be appropriately evaporated without performing strong heating by the heater, or the like. In addition, in this case, since it is unnecessary to perform strong heating by the heater, occurrence of nozzle clogging, and the like can be appropriately prevented. Therefore, with this configuration, for example, a problem that occurs when the solvent UV ink is used in the conventional configuration can be appropriately solved.

Through further thorough researches, the inventor of the present application found features necessary for obtaining such effects and contrived the present disclosure. To solve the problems described above, the present disclosure provides a printing device that performs printing through an inkjet system, and the printing device includes: an inkjet head that ejects an ink; an ultraviolet irradiator that generates an ultraviolet light; and a controller that controls operations of the inkjet head and the ultraviolet irradiator; where the ink contains: a curable substance that is a substance cured by being polymerized in response to irradiation of the ultraviolet light, and a solvent that is compatible with the curable substance; and the controller is configured to: cause the inkjet head to perform an ejecting operation for ejecting the ink onto a medium to be printed; cause the ultraviolet irradiator to perform a viscosity increasing operation for increasing a viscosity of the ink landed on the medium and a curing operation for curing the ink on the medium; cause, in the viscosity increasing operation, the ultraviolet irradiator to irradiate the ink on the medium with the ultraviolet light to evaporate at least a part of the solvent in the ink by heat of polymerization generated by polymerization of the curable substance and increase the viscosity of the ink to a viscosity at which smearing does not occur on the medium; and cause, in the curing operation, the ultraviolet irradiator to irradiate the ink whose viscosity is increased by the viscosity increasing operation with the ultraviolet light to cure the ink on the medium.

With such a configuration, the problem that occurs when the ultraviolet-curable ink is used in the conventional configuration can be appropriately solved while appropriately preventing ink from smearing, for example, by using an ink containing a solvent and increasing the viscosity of the ink in the viscosity increasing operation. Furthermore, in this case, the viscosity of the ink can be appropriately increased without performing strong heating by the heater, for example, by using the heat of polymerization to evaporate the solvent in the ink. Furthermore, for example, this can appropriately prevent the occurrence of nozzle clogging. Thus, according to such a configuration, for example, the printing through the inkjet system can be more appropriately carried out.

Here, in this configuration, the viscosity at which smearing does not occur on the medium can be considered to be, for example, the viscosity at which inter-color smearing, which is a smearing caused by mixing inks of different colors on the medium, does not occur. More specifically, in this configuration, the printing device includes, for example, a plurality of inkjet heads, each of which ejects ink of different colors. Then, in this case, in the viscosity increasing operation, the viscosity of the ink is increased to a viscosity at which inter-color smearing does not occur. The viscosity at which inter-color smearing does not occur can be considered to be, for example, the viscosity at which inks of different colors do not mix with each other when the inks flow on the medium. Furthermore, the viscosity at which smearing does not occur on the medium can be considered to be, for example, the viscosity at which smearing, which is problem in the required print quality, does not occur.

In addition, in this configuration, the ink may further contain, for example, a component same as or similar to a known ultraviolet-curable ink or solvent UV ink. For example, the ink may further include, for example, a coloring material or the like corresponding to the color of the ink. The ink may further contain, for example, an initiator that causes the curable substance to start a polymerization reaction.

Moreover, in this configuration, as the curable substance, for example, a monomer or an oligomer can be preferably used. Furthermore, as the curable substance, for example, it is conceivable to use, as the curable substance, a substance having a viscosity of about 5 to 200 mPa·sec at 25° C. before polymerization. With this configuration, for example, various known monomers and oligomers can be suitably used as the curable substance. Furthermore, in this case, the viscosity of the solvent at 25° C. is preferably smaller than the viscosity of the curable substance and is less than or equal to 5 mPa·sec (e.g., about 0.01 to 5 mPa·sec). The viscosity of the solvent at 25° C. is more preferably less than or equal to 2 mPa·sec. With this configuration, for example, the viscosity of the ink at the time of ejection from the inkjet head can be appropriately reduced. Moreover, in this case, the boiling point of the solvent is preferably lower than or equal to 190° C. (e.g., about 70 to 190° C.). According to this configuration, for example, the solvent can be appropriately evaporated in the viscosity increasing operation. As such a solvent, a known organic solvent or the like can be suitably used.

Furthermore, in this configuration, the ink preferably contains the solvent in an amount of about 5 to 40% by weight with respect to the total weight of the ink. With this configuration, for example, the problem that occurs when the ultraviolet-curable ink is used in the conventional configuration can be more appropriately solved. Furthermore, for example, in the viscosity increasing operation, the solvent can be evaporated more appropriately. The content of the solvent with respect to the total weight of the ink is preferably less than or equal to 30% by weight (e.g., about 5 to 30% by weight), more preferably less than or equal to 20% by weight (e.g., about 10 to 20% by weight).

Furthermore, it can be considered that the amount of the solvent contained in the ink is, for example, preferably set to an amount in a range that can be evaporated by the heat of polymerization generated by the curable substance contained in the ink in the viscosity increasing operation. In this case, the amount in the range that can be evaporated by the heat of polymerization may be considered to be, for example, the amount that can evaporate a sufficient amount of solvent to an extent the purpose of preventing ink smearing can be achieved. According to this configuration, for example, the ink smearing can be appropriately prevented from occurring by performing the viscosity increasing operation.

More specifically, in the viscosity increasing operation, the controller, for example, is configured to cause the ultraviolet irradiator to irradiate the ink on the medium with ultraviolet light to evaporate greater than or equal to 50% by weight (e.g., 50 to 99% by weight) of the solvent in the ink. According to this configuration, the viscosity of the ink can be appropriately increased in the viscosity increasing operation. Furthermore, for example, when ink that is more like to smear is used, it is preferable to evaporate greater than or equal to 70% by weight of the solvent in the ink in the viscosity increasing operation. Moreover, when ink that is more like to smear is used, it is preferable to evaporate greater than or equal to 90% by weight of the solvent in the ink in the viscosity increasing operation.

Furthermore, in the viscosity increasing operation, for example, it is preferable to increase the viscosity of the ink by using the heat of polymerization generated by the polymerization of the curable substance without using a heater. In this case, the heater can be considered as, for example, a heat generator that performs heating by transmitting heat generated by itself. Furthermore, the heater can be considered as, for example, a heat source that heats the ink through the medium by transmitting heat to the medium. When configured in such a manner, for example, since it is not necessary to use a heater, the cost of the printing device can be appropriately reduced.

Furthermore, in this configuration, it is conceivable to flatten the ink dots after the viscosity of the ink is increased in the viscosity increasing operation until the ink is cured in the curing operation. More specifically, in this case, the controller is configured to cause the ultraviolet irradiator to irradiate the ink on the medium with ultraviolet light in the viscosity increasing operation, so that the viscosity of the ink is increased to a viscosity at which smearing does not occur on the medium and the flattening of the ink dots progresses. Then, after the viscosity of the ink is increased by the viscosity increasing operation, the controller is configured to cause the ultraviolet irradiator to apply the ultraviolet light in the curing operation in a state where the ink dots are flattened more than immediately after the ultraviolet light is applied in the viscosity increasing operation. According to such a configuration, for example, thickening of ink and generation of matte can be more appropriately prevented.

It is conceivable to use a printing method having features similar to the above, and the like for the configuration of the present disclosure. In this case as well, for example, effects similar to the above can be obtained.

According to the present disclosure, for example, printing through the inkjet system can be more appropriately performed.

### BRIEF DESCRIPTION OF THE DRAWINGS

FIGS. 1A and 1B are views for showing one example of a printing device 10 according to one embodiment of the present disclosure. FIG. 1A is a top view and FIG. 1B is a side cross-sectional view for showing an example of a configuration of a main part of the printing device 10 in a simplified manner.

FIG. 2 is a graph for showing an example of a relationship between the ratio of the solvent contained in the ink and the viscosity of the ink.

FIGS. 3A and 3B are views for describing the head portion 12 in more detail. FIG. 3A shows an example of the arrangement of the inkjet heads 102y to 102k, the drying light source 112, and the curing light source 114 in the head portion 12. FIG. 3B shows a modified example of a configuration of the head portion 12.

FIG. 4 is a view for showing a further modified example of the configuration of the head portion 12.

FIGS. 5A and 5B are graphs for showing characteristics of the complete seven-color color separation system. FIG. 5A shows an example of a relationship between the capacity of ink printed per unit volume of the medium 50 (ink volume) and the number of gradations of data.

FIG. 5B shows an example of a relationship between the density of ink printed on the medium and the number of gradations of data.

FIG. 6 is a view for showing a modified example of the configuration of the printing device 10.

### DESCRIPTION OF EMBODIMENTS

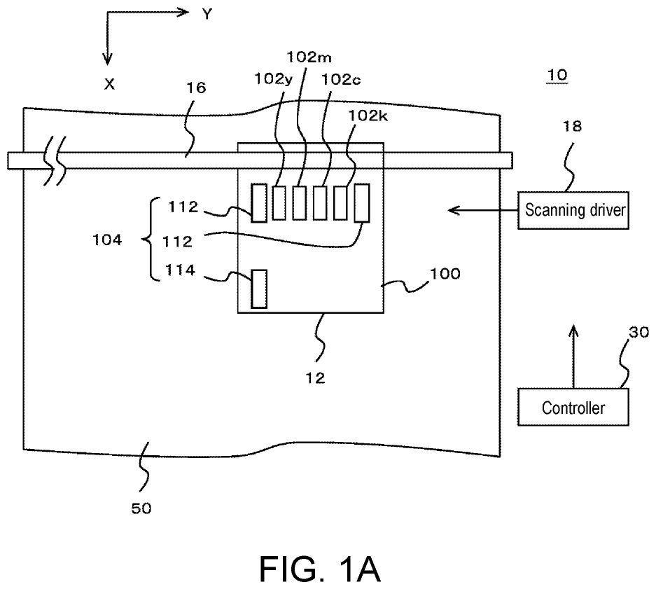

Hereinafter, an embodiment according to the present disclosure will be described with reference to the drawings. FIGS. 1A and 1B show one example of a printing device 10 according to one embodiment of the present disclosure. FIG. 1A is a top view and FIG. 1B is a side cross-sectional view for showing an example of a configuration of a main part of the printing device 10 in a simplified manner. Note that, other than the points described below, the printing device 10 may have features same as or similar to the known printing devices. For example, in addition to the configurations described below, the printing device 10 may further include various configurations same as or similar to the known printing devices.

In the present example, the printing device 10 is an inkjet printer that performs printing on a medium (media) 50 to be printed through an inkjet system, and includes a head portion 12, a platen 14, a guide rail 16, a scanning driver 18, and a controller 30. The head portion 12 is a part that ejects ink onto the medium 50. In the present example, the head portion 12 includes a carriage 100, plurality of inkjet heads 102, and an ultraviolet irradiator 104. The carriage 100 is a holding member that holds other members in the head portion 12, and holds the plurality of inkjet heads 102 and the ultraviolet irradiator 104 so that the ejecting direction of ink by the plurality of inkjet heads 102 and the emitting direction of ultraviolet light by the ultraviolet irradiator 104 are directed toward the medium 50.

Furthermore, in the present example, as shown in FIG. 1A, the head portion 12 includes, as a plurality of inkjet heads 102, an inkjet head 102y, an inkjet head 102m, an inkjet head 102c, and an inkjet head 102k (hereinafter referred to as inkjet heads 102y to 102k). The inkjet head 102y ejects ink of yellow color (Y color). The inkjet head 102m ejects ink of magenta color (M color). The inkjet head 102c ejects ink of cyan color (C color). The inkjet head 102k ejects ink of black color (K color).

Furthermore, as shown in the figure, the inkjet heads 102y to 102k are arranged in a Y direction (Y axis direction) orthogonal to an X direction (X axis direction) with the positions in the X direction aligned. In this case, the X direction is a direction parallel to the sub scanning direction in which the head portion 12 is moved relative to the medium 50 at the time of sub scan to be described later. Furthermore, the Y direction is a direction parallel to the main scanning direction in which the head portion 12 is moved relative to the medium 50 at the time of main scan to be described later. In addition, in the present example, the inkjet heads 102y to 102k are examples of a plurality of inkjet heads that eject inks of different colors. The ink of each color ejected from the inkjet heads 102y to 102k can be considered as, for example, an example of the color ink of each color for color printing.

Furthermore, in the present example, the ink of each color ejected from the inkjet heads 102y to 102k contains a curable substance which is a substance that is cured by being polymerized in response to the emission of ultraviolet light, and a solvent having compatibility with the curable substance. In this case, the ink used in the present example can be considered to be, for example, an ink in which a small amount of solvent is added to the ultraviolet-curable ink. Furthermore, the solvent can be considered as, for example, a solvent (dilution solvent) for diluting the ultraviolet-curable ink. Moreover, in this example, a monomer or an oligomer is used as the curable substance. In addition, this ink may further contain, for example, a component same as or similar to a known ultraviolet-curable ink or solvent UV ink. For example, in the present example, the ink further includes a color material or the like corresponding to the color of the ink. Furthermore, the ink further contains, for example, an initiator that causes the curable substance to start a polymerization reaction. In this case, the initiator can be considered to be, for example, an ultraviolet absorber or a sensitizer. The features of the ink to be used in the present example will be described in more detail later.

The ultraviolet irradiator 104 is a light source portion that generates ultraviolet light toward the ink that has landed on the medium 50. Furthermore, in the present example, the ultraviolet irradiator 104 has a plurality of drying light sources 112 and a curing light source 114. In this case, the plurality of drying light sources 112 can be considered as, for example, a light source that emits ultraviolet light for the purpose of evaporating the solvent in the ink. Moreover, the curing light source 114 can be considered as a light source or the like that emits ultraviolet light for the purpose of curing the ink.

In this example, each of the plurality of drying light sources 112 is disposed on the one side and the other side of the inkjet heads 102y to 102k in the main scanning direction while aligning the positions in the sub scanning direction with the inkjet heads 102y to 102k, thus irradiating the ink on the medium 50 with ultraviolet light during the main scan. Furthermore, in this case, it is conceivable that, of the plurality of drying light sources 112, the drying light source 112 on the back side in the moving direction of the inkjet heads 102y to 102k emits the ultraviolet light. According to this configuration, for example, the ink immediately after landing on the medium 50 can be appropriately irradiated with the ultraviolet light.

Furthermore, in this case, the drying light source 112 progresses the polymerization reaction of the curable substance to some extent by irradiates the ink on the medium 50 with the ultraviolet light. In this case, the progress of the polymerization reaction of the curable substance to some extent can be considered to be, for example, curing to a state in which the curing is not completely completed and the ink has viscosity. Furthermore, in this example, the drying light source 112 uses the heat of polymerization generated by the polymerization of the curable substance to evaporate the solvent in the ink. The operation of the drying light source 112 can also be considered as, for example, an operation of evaporating at least a part of the solvent in the ink by the heat of polymerization. In this case, the drying light source 112 increases the viscosity of the ink to a viscosity at which smearing does not occur on the medium 50 by evaporating the solvent in the ink.

For example, ultraviolet LED (UV LED) that generates ultraviolet light can be suitably used as the drying light source 112. Furthermore, in this case, for example, it is preferable to use the UV LED having a light emission peak wavelength at a position matched with the absorption wavelength of the initiator contained in the ink. More specifically, as the drying light source 112, for example, the UV LED or the like having the light emission peak wavelength in the vicinity of 280 to 405 nm (e.g., about 350 nm) can be preferably used. In addition, it is conceivable to use a substance that undergoes radical polymerization, for example, as the curable substance. In this case, the heat of polymerization generated by the polymerization of the curable substance can be considered as the heat of radical polymerization. Furthermore, regarding increasing the viscosity of the ink by evaporating the solvent in the ink, for example, it can be considered that the viscosity of the ink is increased by evaporating at least a part of the solvent in the ink in a state in which the polymerization reaction of the curable substance is progressed to some extent. Moreover, the viscosity at which smearing does not occur on the medium 50 can be considered to be, for example, the viscosity at which inter-color smearing, which is smearing that occurs when inks of different colors are mixed on the medium 50, does not occur. In addition, the viscosity at which inter-color smearing does not occur can be considered to be, for example, the viscosity at which inks of different colors do not mix with each other when the inks flow on the medium 50. Furthermore, the viscosity at which smearing does not occur on the medium 50 can be considered to be, for example, the viscosity at which smearing, which is problem in the required print quality, does not occur.

Furthermore, at the time of emission of the ultraviolet light by the drying light source 112, a process in which the ink is directly heated by the ultraviolet light absorbed in the ink components slightly occurs in addition to the process in which the ink is heated by the heat of polymerization such as heat of radical polymerization. For example, depending on the coloring material added to the ink, ultraviolet light may be absorbed by the coloring material to heat the ink. More specifically, for example, when a coloring material such as a carbon pigment is used, the ink may be heated in such a manner. However, even when such a heating process is taken into consideration, the ink used in the present example can be considered as an ink that can prevent the smearing by evaporating the solvent in the ink by the heat of polymerization. Furthermore, in this case, it is possible to confirm that the solvent can be effectively evaporated by the heat of polymerization, for example, by conducting an experiment using an ink added with no coloring material. Furthermore, in the ink, for example, it is conceivable that the solvent is directly heated to some extent by the influence of the ultraviolet light absorbed by the initiator (ultraviolet absorber) dissolved in the solvent. Therefore, at the time of emission of the ultraviolet light by the drying light source 112, evaporating the solvent in the ink by the heat of polymerization can be considered as, for example, evaporating the solvent by generating the main heat quantity by the heat of polymerization such as the heat of radical polymerization. Furthermore, the operation of increasing the viscosity of the ink by the drying light source 112 will be described in more detail later in the description of the operation of the printing device 10.

Furthermore, in the present example, the curing light source 114 is disposed while shifting the position in the sub scanning direction with the inkjet heads 102y to 102k and the plurality of drying light sources 112 to emit the ultraviolet light after the ink at each position of the medium 50 is irradiated with the ultraviolet light from the drying light source 112. Thus, the curing light source 114 further irradiates the ink in a state in which the viscosity is increased with ultraviolet light to cure the ink. In this case, curing the ink can be considered as, for example, curing the ink to a state in which the curing can be said to be completed according to the quality required for printing, and the like. Furthermore, the state in which the curing of the ink is completed can be considered to be, for example, the state in which the ink is cured to a state in which the viscosity of the ink is lost.

As the curing light source 114, for example, the UV LED or the like which is the same as or similar to the drying light source 112 can be preferably used. Further, in the present example, the curing light source 114 is disposed at a position spaced apart from the drying light source 112 in the sub scanning direction, as shown in the figure. In this case, for example, the time from when the drying light source 112 emits the ultraviolet light until the curing light source 114 emits the ultraviolet light can be adjusted by adjusting a distance L in the sub scanning direction between the drying light source 112 and the curing light source 114. The operation of curing the ink by the curing light source 114 will also be described in more detail later in the description of the operation of the printing device 10.

The platen 14 is a table-like member that supports the medium 50, and supports the medium 50 so as to face the head portion 12. The guide rail 16 is a rail member that guides the movement of the head portion 12 at the time of main scan. The scanning driver 18 is a driver that causes the head portion 12 to perform the main scan and the sub scan. In this case, causing the head portion 12 to perform the main scan and the sub scan can be considered, for example, causing the inkjet heads 102y to 102k in the head portion 12 to perform the main scan and the sub scan. In this case, the main scan is, for example, an operation of ejecting ink while moving relatively to the medium 50 in the main scanning direction. At the time of the main scan, the scanning driver 18 moves each component in the head portion 12 by, for example, moving the carriage 100 along the guide rail 16. Furthermore, the inkjet heads 102y to 102k are caused to draw an image by causing the inkjet heads y to k to eject ink according to the image to be printed.

Furthermore, the scanning driver 18 changes the region facing the head portion 12 in the medium 50 by performing the drive of the sub scan between the main scans. In this case, the sub scan is, for example, an operation of moving relatively to the medium 50 in the sub scanning direction. The scanning driver 18 performs the driving of the sub scan by, for example, driving a roller (not shown) and the like and moving the medium 50 in a conveyance direction parallel to the sub scanning direction.

The controller 30 is, for example, a CPU of the printing device 10, and controls the operation of each portion of the printing device 10. More specifically, the controller 30 causes the inkjet heads 102y to 102k to draw the image to be printed by, for example, causing the inkjet heads 102y to 102k to eject ink onto the respective positions of the medium 50. Furthermore, for example, the controller 30 controls the operation of increasing the viscosity of the ink and the operation of curing the ink by causing the plurality of drying light sources 112 and the curing light source 114 in the ultraviolet irradiator 104 to emit the ultraviolet light. According to the present example, for example, the operation of printing to the medium 50 can be appropriately carried out.

Next, the features of the used in the present example will be described in more detail. As described above, the ink used in this example contains a curable substance and a solvent. In this case, it is conceivable to use, as the curable substance, for example, a substance having a viscosity of about 5 to 200 mPa·sec at 25° C. before polymerization. With this configuration, for example, various known monomers and oligomers can be suitably used as the curable substance. The viscosity of the curable substance at 25° C. before polymerization is more preferably about 10 to 50 mPa·sec. Furthermore, more specifically, as the curable substance, a known monomer or oligomer used in the ultraviolet-curable ink can be preferably used. Moreover, in this example, the curable substance is made into a resin by being cured by a polymerization reaction. The curable substance can be considered to be, for example, a component (UV curable component) that cures when irradiated with ultraviolet light.

In the present example, the curable substance is contained in the ink as a main component. In this case, the main component of the ink can be considered as, for example, the component contained in the ink in the largest weight ratio. The proportion of the curable substance in the ink may be greater than or equal to 50% by weight. Furthermore, in the present example, it can be considered that the curable substance in a state before being irradiated with ultraviolet light functions as a solvent in the ink. In this case, the solvent can be considered as, for example, a liquid or a fluid that dissolves or disperses other components. Then, in this case, of the components of the ink, the curable substance can be considered as the first solvent, and the solvent can be considered as the second solvent.

Furthermore, in the ink of the present example, for example, various liquids such as water or an organic solvent (solvent) can be used as the solvent as long as they are compatible with the curable substance. In this case, the viscosity of the solvent at 25° C. is preferably smaller than the viscosity of the curable substance and is less than or equal to 5 mPa·sec (e.g., about 0.01 to 5 mPa·sec). In such a configuration, since the ink contains a solvent having a low viscosity, for example, the viscosity of the ink at the time of ejection from the inkjet heads 102y to 102k can be appropriately reduced.

Furthermore, as described above, in the present example, the ink is irradiated with ultraviolet light from the drying light source 112, so that the solvent in the ink can be evaporated using the heat of polymerization generated by the curable substance. Therefore, as the solvent, it is conceivable to use a liquid having a boiling point capable of evaporating the solvent by the heat of polymerization. Furthermore, in this case, for example, it is preferable that the temperature rise of the ink caused by the heat of polymerization is to a temperature at which the medium 50 or the ink does not burn. In this case, the boiling point of the solvent is preferably about lower than or equal to 190° C. (e.g., about 70 to 190° C.). According to this configuration, for example, the heat of polymerization can be utilized to appropriately evaporate the solvent when the drying light source 112 emits the ultraviolet light. As such a solvent, a known organic solvent or the like can be suitably used. Furthermore, the boiling point of the solvent used in the present example can be considered to be, for example, the boiling point at which the solvent can be evaporated by utilizing the heat of polymerization generated by the curable substance contained in the ink.

Even when the boiling point of the solvent is sufficiently low, if the amount of solvent contained in the ink is too large, the viscosity of the ink may not be appropriately increased. In this case, for example, the maximum amount of solvent that the ink can contain (maximum amount of solvent that can be blended) is determined according to, for example, a condition that the solvent can be dried by the heat of polymerization generated by the curable substance contained in the ink). In this case, for example, when the total weight of the curable substance contained in a predetermined amount of ink is M, the amount of the solvent added to the ink is considered to be less than or equal to a certain amount determined according to the total weight M of the curable substance. Furthermore, more specifically, in a case where a solvent that is widely used as a solvent for ink (normal solvent) is considered, comparing the heat of evaporation of the solvent per mol, and a polymerization heat quantity (e.g., radical polymerization heat quantity) generated through polymerization by the curable substance per mol, the polymerization heat quantity is considered to be a fraction to less than or equal to 1/10 of the heat of evaporation of the solvent. Moreover, in order to evaporate the solvent from the ink on the medium 50, in addition to the energy corresponding to the heat of evaporation of the solvent, energy for raising the temperature of the ink and the medium 50, energy lost through the medium 50 (heat loss), and the like are also required. In this case, the amount of the solvent that can be evaporated by the heat of polymerization is considered to be less than or equal to 40% by weight (≤0.4 M) with respect to the weight of the curable substance. Furthermore, the amount of the solvent with respect to the weight of the curable substance is preferably less than or equal to 30% by weight (≤0.3M). Moreover, in consideration of more reliable evaporation of the solvent, the amount of the solvent with respect to the weight of the curable substance can be considered to be preferably less than or equal to 10% by weight (≤0.1 M).

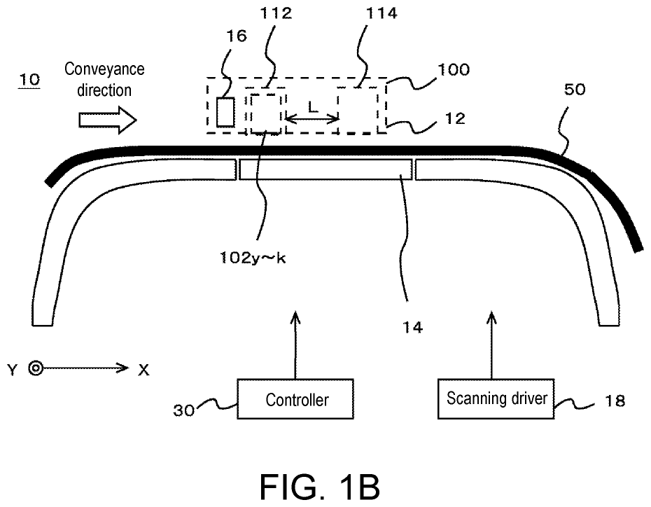

Furthermore, the maximum amount of solvent in the ink is preferably determined in consideration of the smearing speed of the ink. More specifically, if a state of low viscosity continues in the ink that has landed on the medium 50, smearing may occur in the image due to the spread on the surface of the medium 50 or penetration into the medium 50. Furthermore, in this case, it is conceivable that inter-color smearing may occur due to mixing of inks of different colors. On the other hand, in order to prevent smearing, it is conceivable to increase the viscosity of the ink after the ink has landed on the medium 50 and before the smearing occurs. Furthermore, in the present example, as described above, the drying light source 112 irradiates the ink with ultraviolet light to evaporate at least a part of the solvent in the ink and increase the viscosity of the ink. In this case, for example, when the time for performing one main scan is tp, the viscosity of the ink is preferably increased to tens to hundreds mPa·sec or more, which is the viscosity at which the smearing stops, within a time of about tp to several tp, which is the time one to several times longer than tp. In this case, the time tp can be considered as, for example, the scanning time for one pass. Furthermore, the time of tp to several tp is considered to be usually a time of about 0.5 to several seconds. In this case, it is conceivable to set the maximum amount of the solvent in the ink in consideration of, for example, the relationship between the ratio of the solvent in the ink and the viscosity of the ink as shown in FIG. 2.

FIG. 2 is a graph for showing an example of the relationship between the ratio of the solvent contained in the ink and the viscosity of the ink, and shows an example of the change in viscosity in a case where the solvent is added at various ratios with respect to the three types of ink having different viscosities in a state where the solvent is not added. More specifically, in FIG. 2, the relationship between the addition amount of the solvent and the viscosity of the ink after dilution is shown for a case where the solvent is added at various ratios with respect to the inks A, B, and C, which are ultraviolet-curable inks, having different viscosities (initial viscosity at 100% concentration) in a state where the solvent is not added. In the figure, the dilution solvent ratio indicates the ratio of the weight of the solvent with respect to the weight of the ink in a state where the solvent is added. The viscosity indicates the viscosity of the ink in a state where the solvent is added. Furthermore, the viscosity of each of the inks A to C is 5 mPa·sec, 10 mPa·sec, and 20 mPa·sec in the state where the solvent is not added. As the solvent, DMM (diethylene glycol dimethyl ether) having a viscosity of 1.17 mPa·sec was used. As shown in the figure, when the amount of solvent in the ink becomes smaller than a certain amount, the viscosity of the ink rapidly increases. Then, in this case, when considered together with the results of various experiments conducted by the inventor of the present application, in the ink used in this example, the viscosity of the ink is rapidly increased by emitting ultraviolet light from the drying light source 112, and it can be said that the proportion of the solvent is preferably less than or equal to 40% by weight to prevent ink smearing. The ratio of the solvent in the ink is preferably less than or equal to 30% by weight.

Moreover, it is necessary to avoid the ratio of the solvent contained in the ink from becoming too small. More specifically, as described above, the ink used in the present example can be considered to be, for example, an ink obtained by adding a small amount of a solvent to an ultraviolet-curable ink. In this case, it can be considered that the properties of the ultraviolet-curable ink are improved by adding a small amount of solvent. Therefore, the amount of solvent is preferably an amount that can appropriately improve the properties of the ultraviolet-curable ink.

In this regard, the ultraviolet-curable ink has an excellent property (media-free property) that it can be used when printing on various types of media 50. However, in a case of the conventional ultraviolet-curable ink, the viscosity tends to be high, and thickening of ink and generation of matte tend to easily occur at the time of printing. On the other hand, in the present example, since the ink contains the solvent, the viscosity of the ink can be appropriately reduced. Furthermore, in this case, by increasing the amount (ratio) of solvent to be larger than a certain amount, the ink dots after landing on the medium 50 can be flattened and thickening of ink or generation of matte can be prevented. Then, in this case, it is conceivable to set the maximum amount of solvent in the ink in view of, for example, flattening the ink dots on the medium 50. In this case, when considered together with the matters shown in FIG. 2 and the results of various experiments conducted by the inventor of the present application, it can be said that the proportion of the solvent is preferably greater than or equal to 5% by weight. From the viewpoint of more appropriately flattening the dots, it can be considered that the proportion of the solvent is preferably greater than or equal to 10% by weight.

It is to be noted that, for example, when the ultraviolet-curable ink in which the solvent is not added (normal ultraviolet-curable ink that does not contain an evaporation component) is used, the final stable shape for the shape of the ink dots that landed on the medium 50 (e.g., shape after connecting to the dots in adjacent positions) is considered to be determined by, for example, the relationship between the surface tension of the ink and the interfacial tension of the medium 50, and the like. In this case, it can be generally considered that the time until the shape of the ink droplet reaches the stable point becomes longer (slower) as the viscosity of the ink increases.

Furthermore, in the case of a printing device that performs a main scan, the time tp for performing one main scan can be considered to be usually about 0.5 seconds to several seconds. Furthermore, in a printing device (multi-pass printer with N pass numbers) that performs printing through a multi-pass method of performing N main scans with respect to each position of the medium 50, the pass number N is considered to be usually about 8 to 32 times. In this case, for one position of the medium 50, the time from when the ink is ejected in the first main scan until when the last main scan is terminated is considered to be about several dozen seconds to several minutes, which is N times tp. Furthermore, in this case, the flattening of the ink that has landed on the medium 50 is considered to be performed within tp which is the time until the ink has high viscosity (e.g., within about one second), or within the time for several passes (e.g., within about several seconds).

Moreover, when considering the solvent in the ink comprehensively, for example, it may be preferable to determine in consideration of the matters described above within a range in which the media-free properties, which are the characteristics of the ultraviolet-curable ink, are maintained. Furthermore, in this case, considering the drying property of the ink, suppression of smearing, and the flatness of the ink dots formed, the proportion of the solvent contained in the ink is preferably in the range of about 5 to 40% by weight. Moreover, as can be understood from the description made above and the like, the amount of solvent contained in the ink of the present example can be considered to be, for example, the amount in the range that can be evaporated by the heat of polymerization. Furthermore, the amount in the range that can be evaporated by the heat of polymerization may be considered to be, for example, the amount that can evaporate a sufficient amount of solvent to an extent the purpose of preventing ink smearing can be achieved.

Furthermore, in the present example, the medium 50 of various materials and shapes can be used as the medium 50 by maintaining the media-free properties as described above. More specifically, as the medium 50, for example, a medium 50, such as paper or cloth, which is permeable and does not have an image receiving layer, a non-absorbent non-coated medium, and the like can be suitably used. Furthermore, for example, it can be considered to use the medium 50 having an image receiving layer. Moreover, for example, it can also be considered to use a medium 50 having a three-dimensional shape. Furthermore, the medium 50 is not limited to the medium 50 to be the final printed matter, and a medium used for transfer to another medium (transfer medium) or the like can be used.

Next, the printing operation performed in the printing device 10 (see FIGS. 1A and 1B) using the ink as described above will be described in more detail. When performing printing on the medium 50, the controller 30 (see FIGS. 1A and 1B) in the printing device 10 controls the operation of each portion of the printing device 10 to cause the printing device 10 to perform an ejecting operation, a viscosity increasing operation, and a curing operation. In this case, in order to cause the printing device 10 to perform the ejecting operation, the viscosity increasing operation, and the curing operation, the inkjet heads 102y to 102k (see FIGS. 1A and 1B) may be caused to perform the ejecting operation, and the ultraviolet irradiator 104 and the like (see FIGS. 1A and 1B) may be caused to perform the viscosity increasing operation and a curing operation. Furthermore, in this case, the ejecting operation is an operation of causing the inkjet heads 102y to 102k to eject ink onto the medium 50. In this example, the controller 30 controls the operations of the scanning driver 18 (see FIGS. 1A and 1B) and the like to cause the inkjet heads 102y to 102k to perform the main scan, thereby causing the inkjet heads 102y to 102k to perform the ejecting operation.

Furthermore, the viscosity increasing operation is an operation of increasing the viscosity of the ink that has landed on the medium 50. In the present example, the controller 30 causes the drying light source 112 (see FIGS. 1A and 1B) in the ultraviolet irradiator 104 to irradiate the ink on the medium 50 with ultraviolet light, thereby causing the ultraviolet irradiator 104 to perform the viscosity increasing operation. Moreover, in the viscosity increasing operation of the present example, as described above, at least a part of the solvent in the ink is evaporated by the heat of polymerization generated by the polymerization of the curable substance in the ink. As a result, the viscosity of the ink is increased to a viscosity at which smearing does not occur on the medium 50. According to this configuration, for example, the ink smearing can be appropriately prevented from occurring by performing the viscosity increasing operation. Furthermore, in this case, the amount of the solvent contained in the ink of the present example can be considered to be an amount in a range that can be evaporated by the heat of polymerization generated by the curable substance contained in the ink in the viscosity increasing operation.

Furthermore, more specifically, in the viscosity increasing operation, for example, the viscosity of the ink can be increased to a viscosity at which inter-color smearing does not occur. Moreover, in the viscosity increasing operation, the controller 30, for example, causes the drying light source 112 to irradiate the ink on the medium 50 with ultraviolet light to evaporate greater than or equal to 50% by weight (e.g., 50 to 99% by weight) of the solvent in the ink. According to this configuration, for example, the viscosity of the ink can be appropriately increased in the viscosity increasing operation. Furthermore, in the viscosity increasing operation, it is preferable that greater than or equal to 70% by weight of the solvent in the ink is evaporated.

In the operation of irradiating the ink with ultraviolet light from the drying light source 112 in the viscosity increasing operation can be considered to be, for example, primary irradiation of ultraviolet light to the ink. In this case, the drying light source 112 can be considered to be, for example, a light source for primary irradiation of ultraviolet light (UV LED primary irradiator) or the like. Furthermore, the operation of increasing the viscosity of the ink in the viscosity increasing operation can be considered as, for example, an operation of temporarily fixing (primary fixing) the ink to the medium 50 by increasing the viscosity of the ink to the extent that the ink smearing is stopped. Moreover, the viscosity increasing operation can be considered as, for example, an operation of having the ink in a temporarily cured (semi-cured) state by applying ultraviolet light to the extent that the ink is not completely cured, and drying the ink using the heat of polymerization generated at the time of temporary curing. Furthermore, the viscosity increasing operation can be considered as, for example, an operation of increasing the viscosity of the ink to the extent that the flattening of the ink dots progresses thereafter. In this case, in the viscosity increasing operation, for example, the controller 30 causes the drying light source 112 to irradiate the ink on the medium 50 with ultraviolet light, thus increasing the viscosity of the ink to the viscosity at which smearing does not occur on the medium 50 and the flattening of the ink dots progresses.

The curing operation is an operation of curing the ink on the medium 50. In the curing operation of the present example, the controller 30 cures the ink on the medium 50 by causing the curing light source 114 (see FIGS. 1A and 1B) in the ultraviolet irradiator 104 to irradiate the ink, which viscosity has been increased by the viscosity increasing operation, with the ultraviolet light. In this case, for example, after the viscosity of the ink has been increased by the viscosity increasing operation, the controller 30 causes the curing light source 114 to perform the irradiation of ultraviolet light in the curing operation in a state where the ink dots are flattened more than immediately after the ultraviolet light is applied in the viscosity increasing operation. Furthermore, in this case, it is conceivable that the ultraviolet light emitted by the curing light source 114 in the curing operation has a higher intensity than, for example, the ultraviolet light emitted by the drying light source 112 in the viscosity increasing operation. With this configuration, for example, the ink can be more appropriately cured in the curing operation. Moreover, the operation of curing the ink by the ultraviolet light emitted from the curing light source 114 can be considered as, for example, a secondary fixing operation of fixing the ink after the temporary fixing onto the medium 50.

As described above, in the present example, for example, the viscosity of the ink can be appropriately reduced by using the ink containing the solvent. Furthermore, in this case, for example, the ink can be appropriately prevented from smearing by increasing the viscosity of the ink by the viscosity increasing operation immediately after the landing of the ink on the medium 50. For example, the ink dots can be flattened after the viscosity of the ink is increased in the viscosity increasing operation until the ink is cured in the curing operation. Therefore, according to the present example, for example, thickening of ink and generation of matte can be appropriately prevented. This makes it possible to appropriately solve the problems and the like that occur when using an ultraviolet-curable ink that is not diluted with a solvent.

Furthermore, in the present example, for example, the ink can be more appropriately prevented from smearing by adding only a small amount of solvent that can be evaporated by the heat of polymerization to the ink. Moreover, in this case, for example, the viscosity of the ink can be appropriately increased without performing strong heating by the heater, and the like by evaporating the solvent in the ink utilizing the heat of polymerization in the viscosity increasing operation. Furthermore, more specifically, in the viscosity increasing operation of the present example, it is conceivable to increase the viscosity of the ink by using the heat of polymerization generated by the polymerization of the curable substance without using a heater. In this case, the heater can be considered as, for example, a heat generator that performs heating by transmitting heat generated by itself. Furthermore, the heater can be considered as, for example, a heat source that heats the ink through the medium by transmitting heat to the medium. Moreover, the heater can be considered as, for example, a heating portion for raising the temperature of the medium 50. According to the present example, the cost of the printing device can be appropriately reduced as the need for using a heater is eliminated. In this case, for example, nozzle clogging can be appropriately prevented by not performing high-temperature heating by the heater at the position facing the inkjet heads 102y to 102k.

In order to prevent variations in the progress of the polymerization reaction (ultraviolet curing) due to change in room temperature from occurring, heating at room temperature or low temperature of about lower than or equal to room temperature+10° C. may be considered. In this case, for example, it is conceivable to perform preheating on the medium 50. Furthermore, in this case, the printing device 10 may further include a heater, for example, as in a modified example described later.

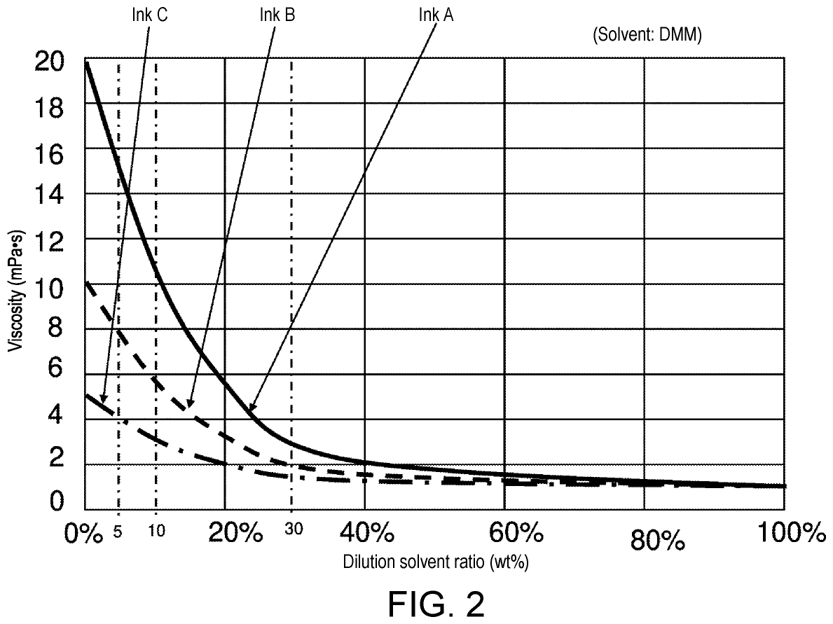

Next, the arrangement of each component in the head portion 12 and modified examples of the configuration of the head portion 12 will be described. FIGS. 3A and 3B are views for describing the head portion 12 in more detail. FIG. 3A shows an example of the arrangement of the inkjet heads 102y to 102k, the drying light source 112, and the curing light source 114 in the head portion 12. Furthermore, for the sake of convenience of illustration, in FIG. 3A, the drying light source 112 is illustrated only on one side in the main scanning direction with respect to the inkjet heads 102y to 102k.

As described above, in the present example, the drying light source 112 is disposed with the positions in the sub-scanning direction aligned with those of the inkjet heads 102y to 102k, so that ink immediately after landing on the medium 50 is irradiated with ultraviolet light during the main scan. Furthermore, in this case, it is conceivable that there is a distance D of a certain extent between the drying light source 112 and the inkjet heads 102y to 102k in the main scanning direction as shown in the figure. Therefore, in this example, irradiating the ink immediately after landing on the medium 50 with the ultraviolet light from the drying light source 112 can be considered as, for example, emitting the ultraviolet light during the main scan while allowing a deviation of about a time corresponding to the distance D.

Furthermore, in this case, by adjusting the distance D, it is possible to adjust the time from the landing on the medium 50 to the irradiation of the ink with ultraviolet light, and the like. More specifically, in this case, for example, it is conceivable to make the distance D larger than a certain extent in a range where ink does not smear. With this configuration, for example, the ink dots can be more appropriately flattened. Furthermore, in this case, the distance D may be considered to be set to a distance in the range of, for example, about 20 to 150 mm.

Furthermore, in the viscosity increasing operation, the viscosity of the ink is increased to a viscosity at which the smearing does not occur on the medium 50 and the flattening of the ink dots progresses. Then, as described above, in the present example, the curing light source 114 is disposed with the positions in the sub scanning direction shifted from those of the inkjet heads 102y to 102k and the plurality of drying light sources 112. In this case, for example, the time from performing the viscosity increasing operation to performing the curing operation can be changed by adjusting the distance L between the drying light source 112 and the curing light source 114 in the sub-scanning direction. Thus, for example, the time for flattening the ink dots can be appropriately secured. According to the present example, the timing of performing the viscosity increasing operation or the curing operation can be adjusted by, for example, changing the distance D or the distance L. Furthermore, in this case, the time for which the drying light source 112 and the curing light source 114 irradiate each position of the medium 50 with the ultraviolet light is assumed to be determined according to, for example, the width W of each of the drying light source 112 and the curing light source 114 in the main scanning direction. Therefore, it is conceivable to also change the width W as necessary.

Here, in the configuration shown in FIGS. 1A, 1B and 3A, the head portion 12 has inkjet heads 102y to 102k for four colors of YMCK. In this case, the configuration of the head portion 12 can be considered to be, for example, a configuration corresponding to a four-color color separation system using inks of four colors. Furthermore, in a modified example of the configuration of the head portion 12, the inkjet head 102 for inks of more colors may be further used. For example, in addition to the four colors of YMCK, it is conceivable to use inks of each color of red color (R color), green color (G color), and blue color (B color). Furthermore, the configuration of the head portion 12 when using such inks of seven colors can be considered as, for example, a configuration corresponding to a seven-color color separation system using inks of seven colors.

FIG. 3B is a view showing a modified example of the configuration of the head portion 12, and shows an example of the configuration of the head portion 12 in the seven-color color separation system. In the present modified example, the head portion 12 includes seven inkjet heads 102 (102y to 102b) lined in the main scanning direction with the positions in the sub-scanning direction aligned. In this case, the inkjet head 102y, the inkjet head 102m, the inkjet head 102c, and the inkjet head 102k eject ink of each color of YMCK, similar to the case of the configuration of the four-color color separation system. Furthermore, the inkjet head 102r ejects R color ink. The inkjet head 102g ejects G color ink. Moreover, the inkjet head 102b ejects B color ink.

When printing is performed by the seven-color color separation system, for example, the total amount of ink used for expressing various colors can be reduced. Furthermore, high-definition printing, and the like can be performed compared to, for example, when printing is performed through the four-color color separation system by further using the inks of the respective colors of RGB. In this case as well, the ejecting operation, the viscosity increasing operation, the curing operation, and the like can be appropriately performed in the same or similar manner as the case described above by using the ink containing the curable substance and the solvent. This makes it possible to flatten the ink dots while preventing ink smearing. Furthermore, in this case as well, the timing and time for applying the ultraviolet light can be appropriately changed by adjusting or changing the distances D and L and the width W shown in the figure.

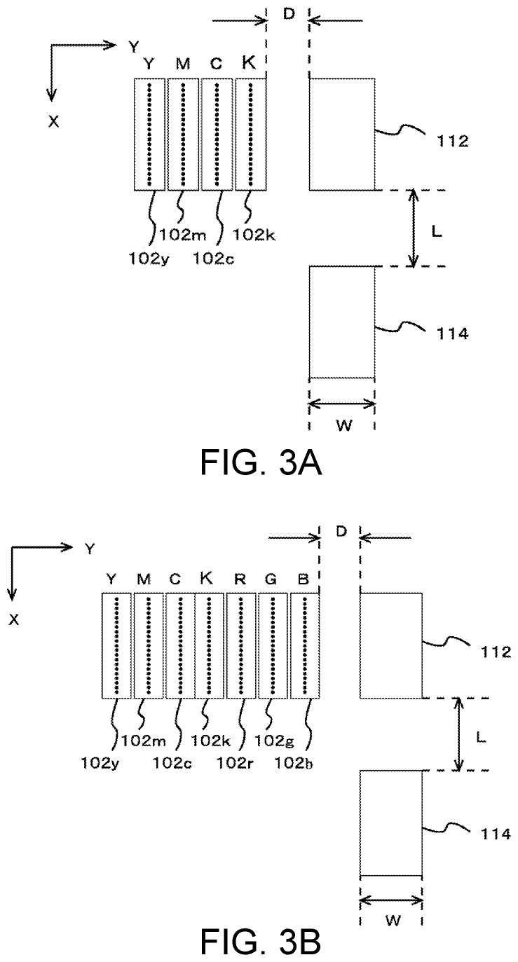

Furthermore, in a case where printing is performed with a seven-color color separation system, in order to more appropriately prevent ink smearing and to speed up the operation of printing, it is conceivable to arrange the inkjet heads 102y to 102b with the positions in the sub scanning direction shifted for each color order, for example, as shown in FIG. 4. FIG. 4 is a view for showing a further modified example of the configuration of the head portion 12, and shows another example of the configuration of the head portion 12 in the seven-color color separation system. In the present modified example, the inkjet heads 102y to 102b for inks of seven colors are disposed with the positions in the sub-scanning direction shifted for each color order. In this case, shifting the position in the sub-scanning direction for each color order can be considered as, for example, shifting the positions in the sub scanning direction by order for the primary color, the secondary color, or the tertiary color inkjet head 102.

In addition, in this modified example, the primary colors are the YMC colors. The secondary color is each color of RGB which is a color obtained by mixing two primary colors. The tertiary color is a K color obtained by mixing three primary colors. According to this modified example, as will be described in detail below, for example, the total amount of ink ejected simultaneously to the same position can be reduced when expressing various colors. Thus, for example, the ink smearing can be more appropriately prevented. Furthermore, in this case, the ink smearing is less likely to occur, so that printing can be performed with, for example, a smaller number of passes. Moreover, for example, this also makes it possible to increase the speed of printing. In this case as well, the ejecting operation, the viscosity increasing operation, the curing operation, and the like can be appropriately performed in the same or similar manner as the case described above by using the ink containing the curable substance and the solvent. This makes it possible to flatten the ink dots while preventing ink smearing.

For the sake of convenience of illustration, the curing light source 114 is omitted in FIG. 4. The curing light source 114 can be considered to be disposed with the positions in the sub scanning direction shifted from those of the inkjet heads 102y to 102k and the plurality of drying light sources 112 similar to, for example, the configuration shown in FIGS. 3A and 3B, and the like. In this case as well, the timing and time for applying the ultraviolet light can be appropriately changed by adjusting or changing the distances and the width corresponding to the distances D and L and the width W shown in FIGS. 3A and 3B.

Furthermore, the configuration of the head portion 12 shown in FIG. 4 can be considered to be, for example, a configuration corresponding to the complete seven-color color separation system. In this case, the complete seven-color color separation system can be considered as, for example, a system in which the print density D and the volume V of the ink landed per unit area of the medium 50 satisfy the following conditions for the primary color, secondary color, and tertiary color inks. More specifically, for the ink of each color of YMCKRGB, when the ink capacity landed per unit area of the medium 50 at the time of 100% printing is assumed as Vy, Vm, Vc, Vk, Vr, Vg, Vb, and the ink print density at the time of 100% printing is assumed as Dy, Dm, Dc, Dk, Dr, Dg, and Db, the relationship of the following equations (1), (2-1), (2-2), (2-3), and (3) is satisfied among the volumes of the primary color, secondary color, and tertiary color (primary color ink volume, secondary color ink volume, and tertiary color ink volume). Furthermore, the relationship of the following equations (4-1), (4-2), (4-3), and (5) is satisfied among the print densities of the primary color, secondary color, and tertiary color (primary color print density, secondary color print density, and tertiary color density).

Vy=Vm=Vc=Vr=Vg=Vb=Vk (1)

α(Vy+Vm)=αVr (2-1)

α(Vm+Vc)=αVb (2-2)

α(Vc+Vy)=αVg (2-3)

αVy=αVm=αVc=αVk (3)

β(Dy+Dm)=βDr (4-1)

β(Dm+Dc)=βDb (4-2)

β(Dc+Dy)=βDg (4-3)

β(Dy+Dm+Dc)=βDk (5)

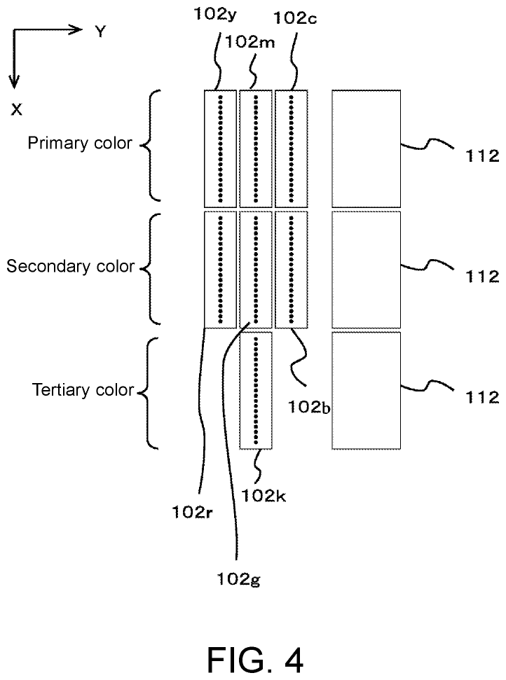

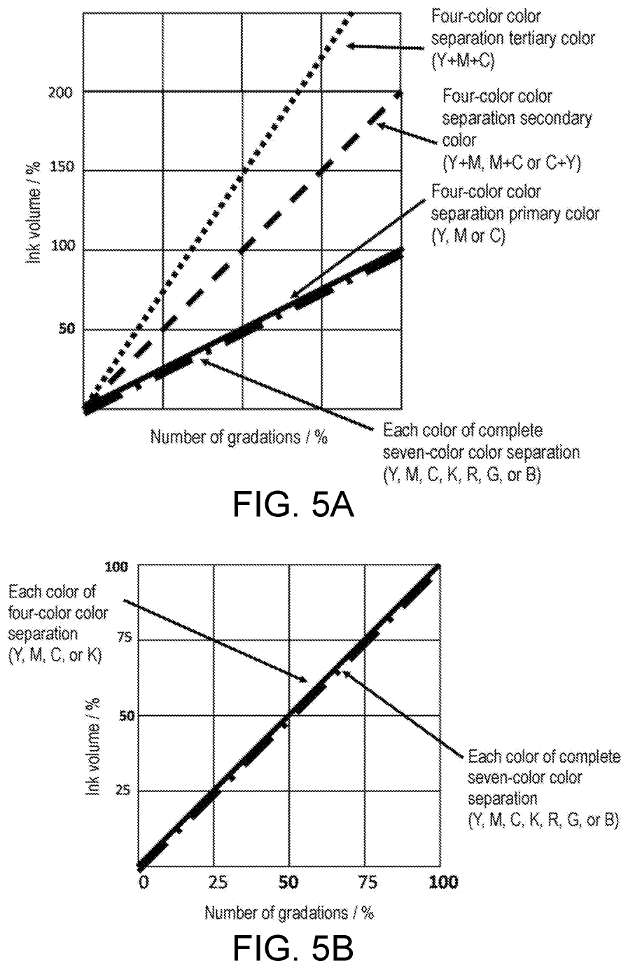

In the above equations, each of α and β represents a ratio when the respective maximum values of the density and the ink volume are assumed as 100, and respectively takes a value between 0 and 100. FIGS. 5A and 5B, for example, show the above relationship in the figure.

FIGS. 5A and 5B are graphs for showing the characteristics of the complete seven-color color separation system. FIG. 5A shows an example of the relationship between the capacity of ink (ink volume) printed per unit area of the medium 50 and the number of gradations of data. FIG. 5B shows an example of the relationship between the density of ink printed on the medium 50 and the number of gradations of data. As can be understood from FIG. 5A and the like, when printing is performed by the four-color color separation system, the amount of secondary color ink is twice as that of the primary color. Furthermore, the amount of tertiary color ink corresponding to the color obtained by mixing YMC is three times as that of the primary color. On the other hand, in the seven-color color separation system, the ink capacity is less than or equal to 100% in all cases.

Furthermore, when the relationship of the equations (4-1) to (4-3) and (5) is satisfied by the complete seven-color color separation system, as can be understood from FIG. 5B and the like, a print image density similar to the four-color color separation system can be realized although the amount of ink is reduced. According to these matters, for example, when using an ink containing a solvent as in each of the configurations described above, it is considered that ink smearing can be more reliably prevented by, for example, using the complete seven-color color separation system. Therefore, when it is particularly important to prevent ink smearing, it can be considered preferable to use the configuration of the complete seven-color color separation system.

Next, supplementary description on each of the configurations described above and further modified examples will be described. In the following description, for the sake of convenience of explanation, the modified examples and the like described above are also encompassed and referred to as the present example. First, the ink used in the present example will be described in more detail. In this example, for example, DMM (diethylene glycol dimethyl ether) or the like can be suitably used as the solvent of the ink. In this case, in an example of the composition of the ink, for example, it is conceivable to add DMM having a viscosity of about 1.17 mPa·sec, for example, as a dilution solvent to the curable substance having an initial viscosity of about 20 mPa·sec, which is the viscosity in a state where no solvent is added. Furthermore, in this case, it is considered that an ink having a viscosity of about 8 mPa·sec is prepared when the addition amount of DMM is set to about 15% by weight.

A substance other than DMM may be used as a solvent of the ink. For example, ethylene glycol monobutyl ether acetate (BMGAC), ethylene glycol monopropyl ether diethylene glycol monobutyl ether (BDG), diethylene glycol ethyl methyl ether (EDM), diethylene glycol diethyl ether (EDE), propylene glycol monomethyl ether (PM), propylene glycol monomethyl ether acetate (PMA), dipropylene glycol monomethyl ether (DPGME), butyl acetate, 3-methoxybutyl acetate and the like can be suitably used. Furthermore, as long as it is a solvent that meets the purpose of diluting the ink to appropriately reduce the viscosity of the ink, it is possible to use various liquids without being limited to a specific solvent.

Moreover, as the curable substance, for example, a monomer or an oligomer whose main reaction is radical polymerization can be preferably used. Furthermore, as such a curable substance, for example, urethane acrylate, polyester acrylate, various acrylate-based monomers, oligomers, and the like can be used. Furthermore, as the curable substance, for example, a cation-based monomer such as an oxetane resin, an epoxy compound, a vinyl ether compound, or an oligomer may be used.

Furthermore, as described above, in the present example, the ink further contains, for example, an initiator (ultraviolet absorber, sensitizer) which causes the curable substance to start the polymerization reaction. As the initiator, for example, a substance having an absorption rate of greater than or equal to 10% when an ink having a thickness of 20 μm is irradiated with ultraviolet light (UV LED light) in the wavelength range of 250 to 400 nm, and the like can be suitably used. In this case, it is conceivable to use an initiator for radical polymerization (a photo-curing initiator used for radical polymerization) or an initiator for cationic polymerization (a photo-curing initiator used for cationic polymerization) depending on the properties of the curable substance. Furthermore, as the initiator for radical polymerization, for example, acetophenone-based initiator such as benzyl dimethyl ketal (type) 1, α-hydroxyacetophenone (type) 2-6, and α-aminoacetophenone (type) 7-9, acylphosphine oxide type initiators such as monoacylphosphine oxide (MAPO) and bisacylphosphine oxide (BAPO), O-acyloxime type initiators such as O-acyloximes 16 and 17, oxime ester-based initiator such as IRGACURE 01 to 02, a titanocene-based initiator such as titanocene, a bimolecular reaction-type initiator such as benzophenone, thioxanthone, or ketocoumarin, and the like may be used. As the initiator for cationic polymerization, for example, an onium salt-based initiator such as onium salts 27 to 2, iodonium salts, iodonium salts 24, nonionic diaryl iodonium salts, triaryl iodonium salts, diphenyl iodonium salts, and sulfonium salts, a nonionic initiator such as imide sulfonate, oxime sulfonate, and the like may be used.

In addition, as described above, in the present example, the ink further contains a coloring material or the like corresponding to the color of the ink. In this case, as the coloring material, for example, known pigments and dyes can be preferably used. Furthermore, the ink may further contain additives such as a viscosity modifier and a dispersant, if necessary. Moreover, as described above, it is conceivable to use ink of each color of YMCK, each color of YMCKRGB, or the like. It is also conceivable to use, other than theses colors, various special colors such as white, pearl, metallic, fluorescent, and phosphorescent colors. Furthermore, the color and the number of colors of the ink are not limited to a specific color as long as it is a color of the number of colors of one or more, and various colors can be used.

Next, effects and the like obtained by the configuration of this example will be described in more detail. As described above, in the present example, through the combination of using an ink having a configuration corresponding to the ultraviolet-curable ink to which a small amount of solvent is added, and evaporating at least a part of the solvent utilizing the heat of polymerization generated by the curable substance in the ink, thickening of ink and generation of matte, which were the drawbacks of the conventional ultraviolet-curable ink, can be avoided while appropriately preventing ink smearing from occurring. Furthermore, in this case, the ink smearing is less likely to occur, so that printing can be performed on various media 50, for example, as in the case of using a conventional ultraviolet-curable type. More specifically, in the present example, it is possible to use various materials such as interior materials and building materials as the medium 50. Furthermore, even when such various media 50 are used, for example, a high-quality image can be appropriately printed while appropriately preventing the occurrence of smearing. Moreover, in the present example, for example, the ink dots can be flattened, and hence printing can be appropriately performed even in applications where high gloss is required such as various labels and packages.

Furthermore, as can be understood from the above description and the like, in the present example, the solvent in the ink can be appropriately evaporated without using a heater for heating the medium 50, for example, by utilizing the heat of polymerization. In this case, since it is not necessary to install the heater, for example, the cost of the printing device can be reduced. Furthermore, depending on the configuration of the printing device 10, it may be difficult to install the heater due to its structure. For example, in the flatbed type printing device 10, it may be difficult to install a heater. On the other hand, according to this example, the solvent in the ink can be appropriately evaporated even in the printing device 10 having a configuration in which it is difficult to install the heater.

In addition, depending on the material and shape of the medium 50, it may be difficult to appropriately raise the temperature of the ink even if it is heated by the heater. More specifically, for example, when a thick resin medium 50 such as a smartphone case is used, it may be difficult to raise the temperature of the surface-to-be-printed even if the back surface side of the medium 50 is heated with a heater. Furthermore, when the medium 50 having various shapes is used in the printing device 10, it may be necessary to create a dedicated jig or the like for each medium 50 having a different shape in order to perform heating with the heater. In this case, the trouble and cost for printing will be greatly increased. On the other hand, according to the present example, the solvent can be more appropriately evaporated by directly heating the ink using the heat of polymerization even when the medium 50 of various materials and shapes is used.

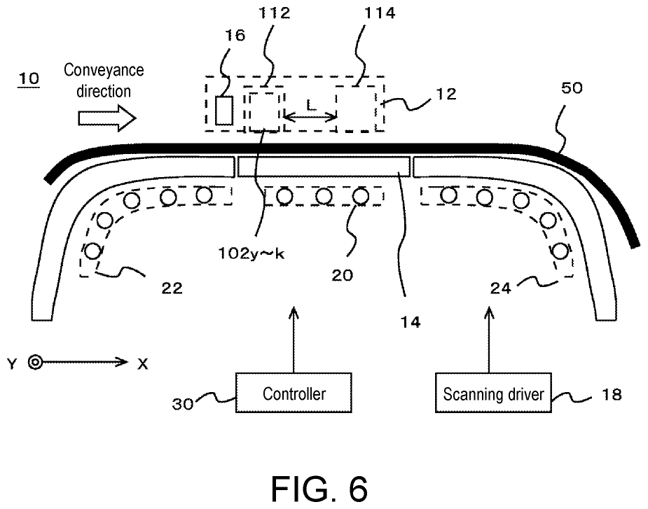

Next, further modified examples of the configuration described above will be described. In the above description, the configuration and operation of the printing device 10 when the solvent in the ink is evaporated without using the heater have been mainly described. However, in a modified example of the configuration of the printing device 10, the heater may be further used to heat the ink. More specifically, for example, when considered to more surely evaporate the solvent in the ink, an after-heater or the like that heats the medium 50 at a position after irradiation with ultraviolet light from the curing light source 114 may be further used. Furthermore, if necessary, a print heater, a pre-heater or the like may be further used, for example, as shown in FIG. 6.

FIG. 6 shows a modified example of the configuration of the printing device 10. Other than the points described below, in FIG. 6, the configuration denoted with the same reference numbers as FIGS. 1A to 5B may have features same as or similar to the configuration in FIGS. 1A to 5B. In this modified example, the printing device 10 further includes a print heater 20, a pre-heater 22, and an after-heater 24, as compared with the printing device 10 having the configuration shown in FIGS. 1A and 1B. The print heater 20 is a heater that heats the medium 50 at a position facing the head portion 12. Furthermore, the pre-heater 22 is a heater that heats the medium 50 on the upstream side of the head portion 12 in the conveyance direction. The after-heater 24 is a heater that heats the medium 50 on the downstream side of the head portion 12 in the conveyance direction. By using these heaters, the solvent in the ink can be more surely evaporated.

Furthermore, as described above, when the solvent in the ink is evaporated by utilizing the heat of polymerization, the solvent can be appropriately evaporated without performing strong heating with the heater such as the print heater 20. Therefore, the heating temperature of the print heater 20 is considered to be set to, for example, a low temperature for the purpose of suppressing the influence of the environmental temperature (e.g., about lower than or equal to 35° C., preferably about 20 to 35° C., more preferably about lower than or equal to 30° C.). With this configuration, for example, it is possible to appropriately prevent nozzle clogging from occurring due to the effect of heating by the print heater 20. Furthermore, in this case, the heating temperature of the pre-heater 22 may be considered to be set to a temperature as low as the heating temperature of the print heater 20.

Furthermore, the after-heater 24 can be considered as, for example, a heater for post-drying. In this case, the after-heater 24 may be considered to perform, for example, heating at a temperature higher than that of the print heater 20. With this configuration, for example, the solvent in the ink can be more surely evaporated. As the after-heater 24, for example, an infrared heater or the like that heats the medium 50 from the surface-to-be-printed side of the medium 50 may be used.

Furthermore, the specific configuration of the printing device 10 is not limited to the configuration described above, and various changes can be further made. For example, the basic configuration of the printing device 10 is not limited to the serial type configuration, and may be the line printer type. Moreover, in this case, it is conceivable to appropriately change the configuration of the ultraviolet irradiator 104 (see FIGS. 1A and 1B) so that the ink after landing on the medium 50 is irradiated with ultraviolet light in accordance with the basic configuration of the printing device 10.

Furthermore, in the description made above, the configuration and the operation have been described with respect to a case where the drying light source 112 is disposed mainly on both sides of the inkjet heads 102y to 102k in the main scanning direction. However, the drying light source 112 may be disposed only on one side of the inkjet heads 102y to 102k. Furthermore, the drying light source 112 may be further disposed, for example, at a position on the downstream side in the conveyance direction of the medium 50.

In the description made above, as an example of the configurations of the drying light source 112 and the curing light source 114, an example in which the same or similar UV LEDs are used in the drying light source 112 and the curing light source 114 has been described. In this case, it can be considered that the drying light source 112 and the curing light source 114 generate the ultraviolet light having the same wavelength (e.g., the same peak wavelength). However, the curing light source 114 may generate, for example, ultraviolet light having a wavelength different from that of the drying light source 112. According to this configuration, for example, the irradiation condition of ultraviolet light in the viscosity increasing operation and the irradiation condition of ultraviolet light in the curing operation can be appropriately made different. This makes it possible to, for example, more appropriately increase the viscosity of the ink without completely curing the ink in the viscosity increasing operation.

Furthermore, in the description made above, an example in which different light sources are mainly used as the drying light source 112 and the curing light source 114 has been described. According to this configuration, for example, the intensity of ultraviolet light to be applied can be adjusted more appropriately in the viscosity increasing operation and the curing operation. Thus, for example, the ink dots can be more appropriately flattened while preventing burn of the ink or the medium 50 from occurring. On the other hand, in a further modified example of the configuration of the printing device 10, for example, it is also conceivable to use a common light source as the drying light source 112 and the curing light source 114. In this case, for example, with respect to the configuration shown in FIGS. 1A and 1B or FIG. 6, it is considered to make changes so that the drying light source 112 also has the function of the curing light source 114, or to make changes so that the curing light source 114 also has the function of the drying light source 112, and the like. Moreover, in this case, in the viscosity increasing operation and the curing operation, it is conceivable that one light source emits the ultraviolet light over a plurality of times with an interval between the timings. More specifically, in this case, for example, it is considered to reciprocate the head portion 12 in the main scanning direction, where ultraviolet light for the ejection of ink and the viscosity increasing operation is applied in the forward path, and ultraviolet light for the curing operation is applied in the backward path.

### INDUSTRIAL APPLICABILITY

The present disclosure can be suitably used for, for example, a printing device.

What is claimed is:

1. A printing device that performs printing through an inkjet system, and the printing device comprising:
an inkjet head that ejects an ink;
an ultraviolet irradiator that generates an ultraviolet light; and
a controller that controls operations of the inkjet head and the ultraviolet irradiator;
wherein the ink contains:
a curable substance that is a substance cured by being polymerized in response to irradiation of the ultraviolet light, and
a solvent that is compatible with the curable substance;
wherein the controller is configured to:
cause the inkjet head to perform an ejecting operation for ejecting the ink onto a medium to be printed,
cause the ultraviolet irradiator to perform a viscosity increasing operation for increasing a viscosity of the ink landed on the medium and a curing operation for curing the ink on the medium,
cause, in the viscosity increasing operation, the ultraviolet irradiator to irradiate the ink on the medium with the ultraviolet light to evaporate at least a part of the solvent in the ink by heat of polymerization generated by polymerization of the curable substance and increase the viscosity of the ink to a viscosity at which smearing does not occur on the medium, and
cause, in the curing operation, the ultraviolet irradiator to irradiate the ink whose viscosity is increased by the viscosity increasing operation with the ultraviolet light to cure the ink on the medium.

2. The printing device according to claim 1, wherein
in the viscosity increasing operation, the viscosity of the ink is increased by heat of polymerization generated by polymerization of the curable substance without using a heater that performs heating by transmitting heat generated by itself.

3. The printing device according to claim 1, wherein
the ink contains an amount of the solvent in a range that is capable of being evaporated by heat of polymerization generated by the curable substance contained in the ink in the viscosity increasing operation.

4. The printing device according to claim 2, wherein
the ink contains an amount of the solvent in a range that is capable of being evaporated by heat of polymerization generated by the curable substance contained in the ink in the viscosity increasing operation.

5. The printing device according to claim 1, wherein
in the viscosity increasing operation, the controller is configured to cause the ultraviolet irradiator to irradiate the ink on the medium with the ultraviolet light to evaporate greater than or equal to 80% by weight of the solvent in the ink.

6. The printing device according to claim 2, wherein
in the viscosity increasing operation, the controller is configured to cause the ultraviolet irradiator to irradiate the ink on the medium with the ultraviolet light to evaporate greater than or equal to 80% by weight of the solvent in the ink.

7. The printing device according to claim 3, wherein
in the viscosity increasing operation, the controller is configured to cause the ultraviolet irradiator to irradiate the ink on the medium with the ultraviolet light to evaporate greater than or equal to 80% by weight of the solvent in the ink.

8. The printing device according to claim 4, wherein
in the viscosity increasing operation, the controller is configured to cause the ultraviolet irradiator to irradiate the ink on the medium with the ultraviolet light to evaporate greater than or equal to 80% by weight of the solvent in the ink.

9. The printing device according to claim 1, wherein
the viscosity of the curable substance before polymerization at 25° C. is 5 to 200 mPa·sec,
the viscosity of the solvent at 25° C. is smaller than the viscosity of the curable substance and is less than or equal to 5 mPa·sec, and
a boiling point of the solvent is lower than or equal to 190° C.

10. The printing device according to claim 1, wherein
the ink contains 5 to 40% by weight of the solvent with respect to a total weight of the ink.

11. The printing device according to claim 1, wherein
in the viscosity increasing operation, the ultraviolet irradiator is configured to irradiate the ink on the medium with the ultraviolet light to increase the viscosity of the ink to a viscosity at which smearing does not occur on the medium and flattening of ink dots progresses, and
after the viscosity of the ink is increased by the viscosity increasing operation, the controller is configured to cause the ultraviolet irradiator to emit ultraviolet light in the curing operation in a state where the ink dots are more flattened than immediately after the irradiation of the ultraviolet light in the viscosity increasing operation.

12. A printing method that performs printing through an inkjet system, and the printing method comprising:
providing an inkjet head that ejects an ink; and
providing an ultraviolet irradiator that generates an ultraviolet light,
wherein the ink contains:
a curable substance that is a substance cured by being polymerized in response to irradiation of the ultraviolet light, and
a solvent that is compatible with the curable substance;
wherein the printing method further comprises:
causing the inkjet head to perform an ejecting operation for ejecting the ink onto a medium to be printed,
causing the ultraviolet irradiator to perform a viscosity increasing operation for increasing a viscosity of the ink landed on the medium and a curing operation for curing the ink on the medium,
causing, in the viscosity increasing operation, the ultraviolet irradiator to irradiate the ink on the medium with the ultraviolet light to evaporate at least a part of the solvent in the ink by heat of polymerization generated by polymerization of the curable substance and increase the viscosity of the ink to a viscosity at which smearing does not occur on the medium, and
causing, in the curing operation, the ultraviolet irradiator to irradiate the ink whose viscosity is increased by the viscosity increasing operation with the ultraviolet light to cure the ink on the medium.
